(19) United States
(12) Patent Application Publication
(10) Pub. No.: US 2023/0373769 A1
(43) Pub. Date: Nov. 23, 2023

(54) AUTOMATED MOVING VEHICLE AND CONTROL METHOD THEREOF

(71) Applicant: Coretronic Intelligent Robotics Corporation, Hsin-Chu (TW)

(72) Inventors: Yen-Yi Chen, Hsin-Chu (TW); Jyun-Siang Fan, Hsin-Chu (TW); Pei-Chi Hsiao, Hsin-Chu (TW); Huai-En Wu, Hsin-Chu (TW)

(73) Assignee: Coretronic Intelligent Robotics Corporation, Hsin-Chu (TW)

(21) Appl. No.: 18/318,714

(22) Filed: May 16, 2023

(30) Foreign Application Priority Data
May 17, 2022 (TW) 111118314

(51) Int. Cl. B66F 9/075; B66F 9/06

(52) U.S. Cl. CPC B66F 9/0755; B66F 9/063

(57) ABSTRACT

An automated moving vehicle and a control method thereof. The control method includes: obtaining a static point cloud and a current point cloud on a work space through a sensor, wherein the current point cloud includes a current scan point; calculating a shortest distance between the current scan point and the static point cloud; in response to the shortest distance being greater than or equal to a first threshold, calculating a first distance between the current scan point and the automated moving vehicle; and in response to the first distance being less than a second threshold, controlling a driving device of the automated moving vehicle to stop a movement of the automated moving vehicle.

### CROSS-REFERENCE TO RELATED APPLICATION

This application claims the priority benefit of Taiwan application serial no. 111118314, filed on May 17, 2022. The entirety of each of the above-mentioned patent applications is hereby incorporated by reference herein and made a part of this specification.

### BACKGROUND

### Technical Field

The disclosure relates to an automated moving vehicle and a control method thereof.

### Description of Related Art

In response to the arrival of the Industry 4.0, many factories have transformed to an automated and intelligent production model. Especially in logistics warehousing systems or smart factories, unmanned trucks or unmanned forklifts are gradually replacing manpower for repetitive goods carrying, loading, or unloading. However, during a mission of an unmanned vehicle, it is inevitable that a collision occurs by moving in the same work space with operators or other unmanned vehicles. Therefore, well-designed obstacle detection and avoidance functions for unmanned vehicles are one of the important topics in this field.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The invention provides an automated moving vehicle and a control method thereof, which may control the automated moving vehicle to avoid different types of obstacles in a suitable manner.

An automated moving vehicle of the invention includes a housing, a sensor, a driving device, and a processor. The sensor is disposed on the housing. The driving device is disposed in the housing. The processor is disposed in the housing and is configured to couple the sensor and the driving device, in which the processor is configured to execute the following processes. A static point cloud and a current point cloud is obtained on a work space through the sensor, in which the current point cloud includes a current scan point. A shortest distance between the current scan point and the static point cloud is calculated. In response to the shortest distance being greater than or equal to a first threshold, a first distance between the current scan point and the automated moving vehicle is calculated. In response to the first distance being less than a second threshold, a driving device is controlled to stop a movement of the automated moving vehicle.

In an embodiment of the invention, the processor is further configured to execute the following process. In response to the shortest distance being less than the first threshold, a moving path of the automated moving vehicle is updated according to the current scan point.

In an embodiment of the invention, the processor is further configured to execute the following process. The moving path is updated such that a second distance between the moving path and the current scan point is greater than or equal to a third threshold.

In an embodiment of the invention, the processor is further configured to execute the following process. In response to the shortest distance being less than the first threshold, the static point cloud is updated according to the current scan point.

In an embodiment of the invention, the processor is further configured to execute the following process. In response to a difference between an acquisition time of a scan point of the static point cloud and a current time being greater than or equal to a time threshold, the scan point is removed from the static point cloud to update the static point cloud.

In an embodiment of the invention, the processor is further configured to execute the following processes. A preset point cloud is obtained corresponding to the work space. In response to the current scan point not overlapping with the preset point cloud, the shortest distance between the current scan point and the static point cloud is calculated.

In an embodiment of the invention, the processor is further configured to execute the following process. A moving path of the automated moving vehicle is determined according to the preset point cloud and the static point cloud.

In an embodiment of the invention, the processor is further configured to execute the following process. The driving device is controlled to move the automated moving vehicle along a moving path before obtaining the current scan point. In response to the shortest distance being greater than or equal to the first threshold, the driving device is controlled to move the automated moving vehicle along the same movement path.

In an embodiment of the invention, the automated moving vehicle further includes an inertial measurement unit. The inertial measurement unit is coupled to the processor and measures an acceleration of the automated moving vehicle, in which the processor determines the second threshold based on the acceleration.

In an embodiment of the invention, the processor is further configured to execute the following processes. The current point cloud is divided into multiple clusters, in which the clusters include a first cluster, in which a distance between each of the first clusters and the static point cloud is greater than or equal to the first threshold. A clustering algorithm is executed on the clusters to update the clusters, and whether the current scan point is located in the first cluster that is updated is determined. In response to the current scan point being located in the first cluster that is updated, the first distance is calculated.

A control method of an automated moving vehicle of the invention includes the following processes. A static point cloud and a current point cloud is obtained on a work space through a sensor, in which the current point cloud includes a current scan point. A shortest distance between the current scan point and the static point cloud is calculated. In response to the shortest distance being greater than or equal to a first threshold, a first distance between the current scan point and the automated moving vehicle is calculated. In response to the first distance being less than a second threshold, a driving device of the automated moving vehicle is controlled to stop a movement of the automated moving vehicle.

Based on the above, the automated moving vehicle of the invention may adopt different mechanisms to avoid obstacles based on the types of obstacles. Accordingly, the automated moving vehicle can move according to the optimal moving path, and can avoid traffic accidents to improve the safety of the work space.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWING

The accompanying drawings are included to provide a further understanding of the invention, and are incorporated in and constitute a part of this specification. The drawings illustrate examples of the invention and, together with the description, serve to explain the principles of the invention.

FIG. 1 is a schematic diagram of an automated moving vehicle according to an embodiment of the invention.

FIG. 2 is a schematic diagram illustrating the appearance of an automated moving vehicle according to an embodiment of the invention.

FIG. 3 is a flowchart illustrating controlling the movement of an automated moving vehicle according to an embodiment of the invention.

FIG. 4 is a schematic diagram of a two-dimensional plane representing a work space according to an embodiment of the invention.

FIG. 5 is a flowchart illustrating a control method of an automated moving vehicle according to an embodiment of the invention.

### DETAILED DESCRIPTION OF DISCLOSED EMBODIMENTS

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected, “coupled,” and “mounted,” and variations thereof herein are used broadly and encompass direct and indirect connections, couplings, and mountings.

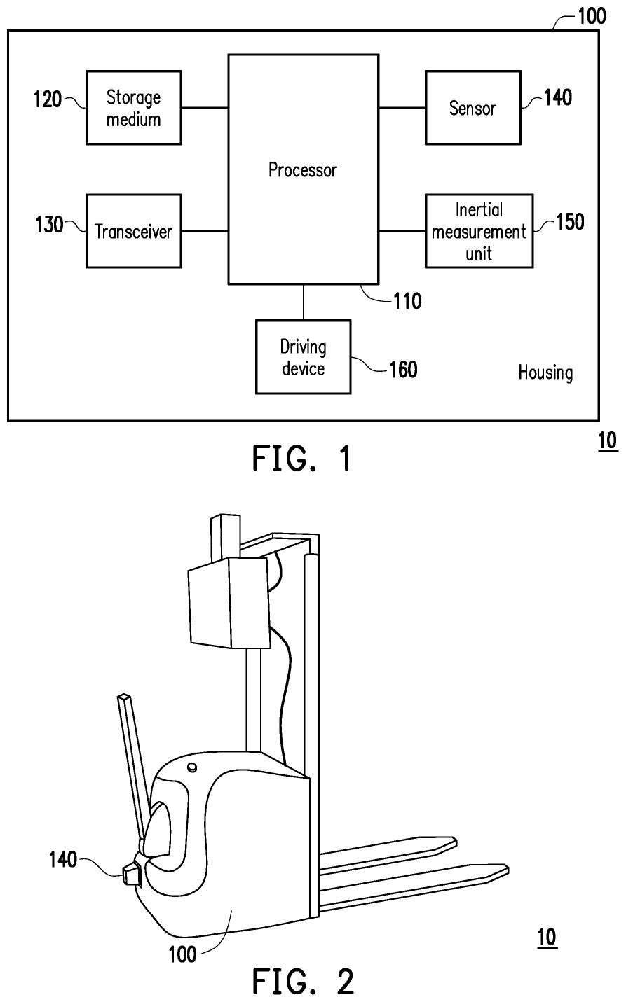

FIG. 1 is a schematic diagram of an automated moving vehicle 10 according to an embodiment of the invention. The automated moving vehicle 10 may include a housing 100, a processor 110, a storage medium 120, a transceiver 130, a sensor 140, an inertial measurement unit (IMU) 150, and a driving device 160.

The processor 110 is disposed in the housing 100. The processor 110 is, for example, a central processing unit (CPU), or other programmable general-purpose or special-purpose micro control unit (MCU), microprocessor, digital signal processor (DSP), programmable controller, application specific integrated circuit (ASIC), graphics processing unit (GPU), image signal processor (ISP), image processing unit (IPU), arithmetic logic unit (ALU), complex programmable logic device (CPLD), field programmable gate array (FPGA), or other similar elements, or a combination of the elements thereof. The processor 110 may be coupled to the storage medium 120, the transceiver 130, the sensor 140, the inertial measurement unit 150, and the driving device 160, and the processor 110 may access and execute multiple modules and various applications stored in the storage medium 120 to execute various functions of the automated moving vehicle 10.

The storage medium 120 may be disposed in the housing 100. The storage medium 120 is, for example, any type of fixed or removable random access memory (RAM), read-only memory (ROM), flash memory, hard disk drive (HDD), solid state drive (SSD), or similar elements, or a combination of the elements thereof configured to store multiple modules or various applications executable by the processor 110.

The transceiver 130 may be disposed in the housing 100. The transceiver 130 transmits and receives signals in a wireless or wired manner. Transceiver 130 may also execute operations such as low noise amplification, impedance matching, frequency mixing, up or down frequency conversion, filtering, amplification, and the like.

The sensor 140 may be disposed at any position of the housing 100 to measure the environment around the automated moving vehicle 10 and generate a point cloud, as shown in FIG. 2. The sensor 140 may include a light detection and ranging (LIDAR) device or an RGB-D depth camera. The LIDAR device is, for example, a two-dimensional LIDAR device or a three-dimensional LIDAR device. The point cloud sensed by the sensor 140 may include a three-dimensional point cloud. The definition of a point cloud is a data set of points in space, which may represent the shape of a three-dimensional (3D) object, and the point cloud may be obtained by a LIDAR device. The processor 110 may obtain a point cloud on a two-dimensional plane through projecting the point cloud on the two-dimensional plane. In the invention, multiple sensors 140 may also be disposed on the housing 100.

The driving device 160 may be disposed in the housing 100 and may be controlled by the processor 110, so as to drive the automated moving vehicle 10 to move. The driving device 160 may include components such as motors, tires, or tracks.

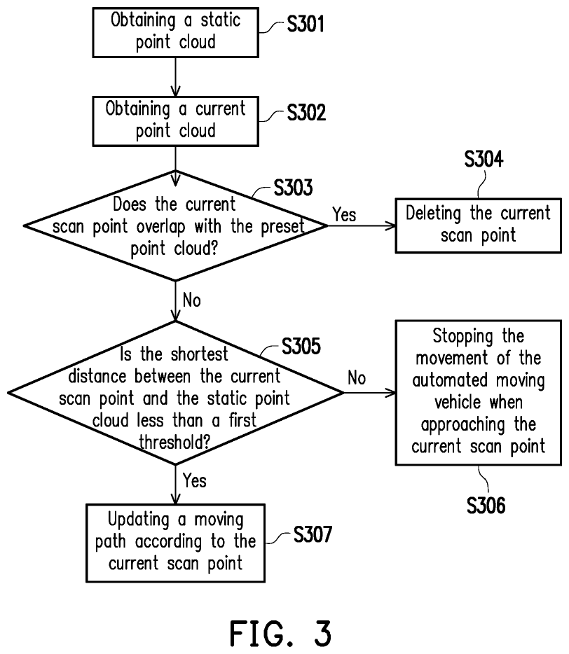

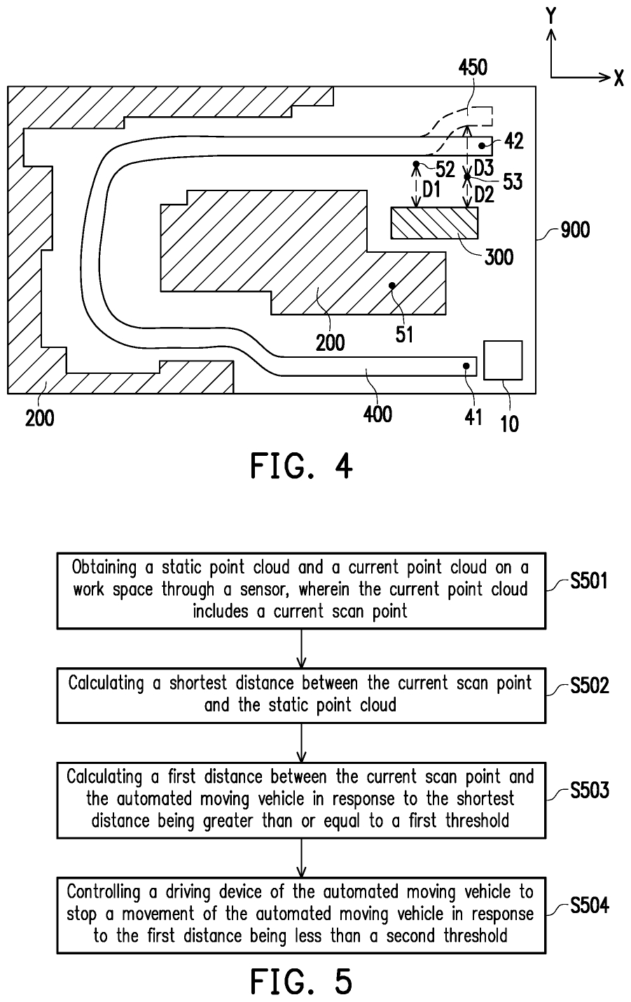

FIG. 3 is a flowchart illustrating controlling the movement of an automated moving vehicle 10 according to an embodiment of the invention. In this embodiment, it is assumed that the automated moving vehicle 10 may execute actions such as moving, carrying goods, or loading and unloading goods in a specific work space. FIG. 4 is a schematic diagram of a two-dimensional plane 900 representing a work space according to an embodiment of the invention. Referring to FIG. 3 and FIG. 4, the processor 110 of the automated moving vehicle 10 may automatically plan a moving path 400 of the automated moving vehicle 10 on the two-dimensional plane 900. For example, the processor 110 may control the automated moving vehicle 10 to move from a starting point 41 along the moving path 400 to an ending point 42.

First, the storage medium 120 of the automated moving vehicle 10 may pre-store the two-dimensional plane 900 of the work space, that is, the data of the two-dimensional plane layout of the work space (such as floor plan). The user may input the data of the moving path 400 (hereinafter referred to as the moving path 400) to the storage medium 120 of the automated moving vehicle 10. When the automated moving vehicle 10 is activated, the processor 110 may read the two-dimensional plane 900 and the moving path 400 as the initial settings for moving the automated moving vehicle 10. When the automated moving vehicle 10 moves, in step S301, the processor 110 may obtain a static point cloud 300 in the work space through the sensor 140. In other words, the processor 110 may generate a three-dimensional point cloud by accumulating the scan points detected by the sensor 140 in the work space over a period of time in the past, and may project the three-dimensional point cloud on the two-dimensional plane 900 (i.e., the XY plane on which the automated moving vehicle 10 travels) as shown in FIG. 4 to generate the static point cloud 300. In order to facilitate the description of the invention, the static point cloud 300 is illustrated with an object temporarily placed in the work space as a representative, as shown in FIG. 4. For example, the sensor 140 may detect movable containers that have been placed in the work space over a period of time in the past, thereby generating the static point cloud 300. The static point cloud 300 may be the basis for the processor 110 to plan a new moving path 400.

The processor 110 may dynamically update the static point cloud 300 to maintain the static point cloud 300 in a latest state. That is, the moving path 400 is maintained in the latest state. In one embodiment, the processor 110 may update the static point cloud 300 according to a time threshold. Assuming that the processor 110 inspect the acquisition time of each scan point of the point cloud 300. As the difference between the acquisition time of the scan point in the static point cloud 300 and the current time is greater than or equal to the time threshold, the processor 110 may remove the scan point from the static point cloud 300 to update the static point cloud 300. For example, the time threshold may be equal to 2 seconds. When the difference between the acquisition time of the scan point in the static point cloud 300 and the current time is greater than or equal to 2 seconds, the processor 110 may delete the scan point from the static point cloud 300. In other words, the static point cloud 300 only includes scan points detected by the sensor 140 in the past 2 seconds, and the scan points existing in the static point cloud 300 for more than 2 seconds may be deleted by the processor 110. The method above may reduce the capacity load of the storage medium 120 and keep the latest static point cloud 300 at any time.

In step S302, the processor 110 may obtain the current point cloud in the work space through the sensor 140. The processor 110 may detect through the sensor 140 at the current time to generate a three-dimensional point cloud, and may project the three-dimensional point cloud on the two-dimensional plane 900 to generate the current point cloud. The current point cloud may include one or more current scan points, such as a current scan point 51, a current scan point 52, or a current scan point 53, as shown in FIG. 4. The current scan points in the current point cloud may correspond to fixed objects in the work space (e.g., walls, beams, or immovable racks), objects temporarily placed in the work space (e.g., movable containers) or objects that move in the work space (e.g.: warehouse managers or other automated moving vehicles). It is worth mentioning that the current scan point 51, the current scan point 52, or the current scan point 53 may be the current scan points generated at different time points, and the reason is that with the movement of the automated moving vehicle, the current scan points are generated through the sensor 140 according to the detection executed in a time sequence.

In step S303, the processor 110 may determine whether the current scan point overlaps with a preset point cloud 200. If the current scan point overlaps with the preset point cloud 200, then go to step S304. If the current scan point does not overlap with the preset point cloud 200, then go to step S305.

In addition, the processor 110 may obtain the preset point cloud 200 of the work space through the transceiver 130. The preset point cloud 200 may represent fixed objects in the work space, such as walls, beams, or immovable racks. The preset point cloud 200 is formed on the two-dimensional plane 900, and the preset point cloud 200 may be the basis for the processor 110 to plan and update the moving path 400. When the processor 110 is planning the moving path 400, the processor 110 may prevent the moving path 400 from overlapping with the preset point cloud 200, or prevent the moving path 400 from being too close to the preset point cloud 200, causing the automated moving vehicle 10 to contact or impact with a fixed object in the work space.

Since the processor 110 certainly avoids the preset point cloud 200 when planning the moving path 400, the current scan point overlapping with the preset point cloud 200 does not become an obstacle for the automated moving vehicle 10, and the current scan point may not be considered when the processor 110 is planning the moving path 400 to save computing resources. Accordingly, in step S304, the processor 110 may delete the current scan point from the two-dimensional plane 900. For example, the processor 110 may determine that the current scan point 51 overlaps with the preset point cloud 200, and classify the current scan point 51 as a useless current scan point. Accordingly, the processor 110 may delete the current scan point 51 from the two-dimensional plane 900.

In step S305, the processor 110 may calculate a shortest distance between the current scan point and the static point cloud 300, and may determine whether the shortest distance is less than a first threshold. If the shortest distance is less than the first threshold, then go to step S307. If the shortest distance is greater than or equal to the first threshold, then go to step S306.

The shortest distance between the current scan point and the static point cloud 300 is less than the first threshold, which represents that the current scan point corresponds to the objects (e.g., movable containers) temporarily placed in the work space, and the current scan point should belong to a portion of the static point cloud 300. The distance between the current scan point and the static point cloud 300 may be caused by the error of the sensor 140. Accordingly, the processor 110 may classify the current scan point as a static current scan point (e.g., the current scan point 53). On the other hand, the shortest distance between the current scan point and the static point cloud 300 is greater than or equal to the first threshold, which represents that the current scan point corresponds to an object (e.g., a warehouse manager) moving in the work space. Accordingly, the processor 110 may classify the current scan point as a dynamic current scan point (e.g., the current scan point 52).

In one embodiment, the processor 110 may add the current scan point (i.e., the static current scan point) to the static point cloud 300 in response to the shortest distance between the current scan point and the static point cloud 300 being less than the first threshold to update the static point cloud 300. For example, if a shortest distance D2 between the current scan point 53 and the static point cloud 300 is less than the first threshold, the processor 110 may determine that the current scan point 53 should belong to a portion of the static point cloud 300. Accordingly, the processor 110 may add the current scan point 53 to the static point cloud 300 to update the static point cloud 300. The processor 110 may re-plan the moving path 400 according to the updated static point cloud 300.

In one embodiment, the processor 110 may divide the dynamic current scan points in the current point cloud into multiple clusters. In other words, the shortest distance between any current scan point in each of the clusters and the static point cloud 300 may be greater than or equal to the first threshold. The processor 110 may execute a clustering algorithm on the clusters to update the clusters. After the update is completed, if the current scan point is still in the original cluster, the processor 110 may execute step S306 according to the current scan point. Taking the current scan point 52 as an example, it is assumed that the clusters include a first cluster, and the first cluster includes the current scan point 52. The processor 110 may execute a clustering algorithm on the clusters to update the clusters. If the current scan point 52 is still in the updated first cluster after the clustering algorithm is executed, it represents that the current scan point 52 is not incorrectly classified as a dynamic current scan point due to influence of the disturbance, noise, or other factors of the sensor 140. Accordingly, the processor 110 may execute step S306 according to the current scan point 52. The clustering algorithm is stored in the storage medium 120, and the clustering algorithm may be read and executed by the processor 110.

In step S306, the processor 110 may control the driving device 160 to stop the movement of the automated moving vehicle 10 when the automated moving vehicle 10 approaches the current scan point. Specifically, the processor 110 may calculate the distance between the current scan point and the automated moving vehicle 10. If the distance between the current scan point and the automated moving vehicle 10 is less than the second threshold, the processor 110 may control the driving device 160 to stop the movement of the automated moving vehicle 10. If the distance between the current scan point and the automated moving vehicle 10 is greater than or equal to the second threshold, the processor 110 may control the driving device 160 to move following the same moving path (i.e., the moving path 400). In other words, when encountering a dynamic current scan point, the processor 110 may avoid the current scan point by stopping the automated moving vehicle 10 without re-planning the moving path 400.

Taking the current scan point 52 as an example, assuming that a shortest distance D1 between the current scan point 52 and the static point cloud 300 is greater than or equal to the first threshold, the processor 110 may determine that the current scan point 52 corresponds to an object (e.g., a warehouse manager) moving in the work space. Since the object corresponding to the current scan point 52 autonomously avoids the automated moving vehicle 10, the processor 110 does not need to change the moving path 400 of the automated moving vehicle 10. The processor 110 only needs to control the driving device 160 to stop the automated moving vehicle 10 when the distance between the automated moving vehicle 10 and the current scan point 52 is less than the second threshold, to avoid the automated moving vehicle 10 from colliding with the object corresponding to the current scan point 52.

In one embodiment, the inertial measurement unit 150 may measure the acceleration of the automated moving vehicle 10. The processor 110 may determine the magnitude of the second threshold according to the acceleration of the automated moving vehicle 10. For example, the processor 110 may calculate the speed of the automated moving vehicle 10 according to the acceleration, and configure the second threshold to be proportional to the speed of the automated moving vehicle 10. In this way, when the speed of the automated moving vehicle 10 is relatively fast, the processor 110 may begin stopping the automated moving vehicle 10 when the distance between the automated moving vehicle 10 and the current scan point is relatively far.

In step S307, the processor 110 may update the moving path 400 according to the current scan point. Specifically, the processor 110 may update the moving path 400 such that the distance between the updated moving path 400 and the current scan point is greater than or equal to a third threshold. Taking the current scan point 53 as an example, assuming that the shortest distance D2 between the current scan point 53 and the static point cloud 300 is less than the first threshold, the processor 110 may determine that the current scan point 53 corresponds to an object temporarily placed in the work space, and the current scan point 53 should belong to a portion of the static point cloud 300. Since the object corresponding to the current scan point 53 does not autonomously avoid the automated moving vehicle 10, the processor 110 may update the moving path 400 to a moving path 450. The driving device 160 may operate the automated moving vehicle 10 to move along the moving path 450 to avoid the object corresponding to the current scan point 53, so that the distance D3 between the current scan point 53 and the moving path 450 is greater than or equal to the third threshold.

FIG. 5 is a flowchart illustrating a control method of an automated moving vehicle according to an embodiment of the invention. The method may be implemented by the automated moving vehicle 10 shown in FIG. 1. In step S501, a static point cloud and a current point cloud on the work space are obtained through a sensor, in which the current point cloud includes a current scan point. In step S502, a shortest distance between the current scan point and the static point cloud is calculated. In step S503, in response to the shortest distance being greater than or equal to the first threshold, a first distance between the current scan point and the automated moving vehicle is calculated. In step S504, in response to the first distance being less than the second threshold, the driving device of the automated moving vehicle is controlled to stop the movement of the automated moving vehicle.

To sum up, the automated moving vehicle of the invention obtains the environmental data in real time to establish a point cloud on a two-dimensional plane and plan a moving path according to the point cloud. When the automated moving vehicle detects an obstacle according to the point cloud, the automated moving vehicle may determine whether the obstacle is a moving object. The automated moving vehicle may adopt different mechanisms to avoid obstacles according to the determination results. The invention may plan the most efficient moving path for the automated moving vehicle, and may avoid the traffic accident of the automated moving vehicle.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby enabling persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An automated moving vehicle, comprising:
a housing;
a sensor, disposed on the housing;
a driving device, disposed in the housing; and
a processor, disposed in the housing and is configured to couple the sensor and the driving device, wherein the processor is configured to execute:
obtaining a static point cloud and a current point cloud in a work space through the sensor, wherein the current point cloud comprises a current scan point;
calculating a shortest distance between the current scan point and the static point cloud;
calculating a first distance between the current scan point and the automated moving vehicle in response to the shortest distance being greater than or equal to a first threshold; and
controlling a driving device to stop a movement of the automated moving vehicle in response to the first distance being less than a second threshold.

2. The automated moving vehicle according to claim 1, wherein the processor is further configured to execute:
updating a moving path of the automated moving vehicle according to the current scan point in response to the shortest distance being less than the first threshold.

3. The automated moving vehicle according to claim 2, wherein the processor is further configured to execute:
updating the moving path such that a second distance between the moving path and the current scan point is greater than or equal to a third threshold.

4. The automated moving vehicle according to claim 1, wherein the processor is further configured to execute:
updating the static point cloud according to the current scan point in response to the shortest distance being less than the first threshold.

5. The automated moving vehicle according to claim 1, wherein the processor is further configured to execute:
removing a scan point of the static point cloud from the static point cloud to update the static point cloud in response to a difference between an acquisition time of the scan point of the static point cloud and a current time being greater than or equal to a time threshold.

6. The automated moving vehicle according to claim 1, wherein the processor is further configured to execute:
obtaining a preset point cloud corresponding to the work space; and
calculating the shortest distance between the current scan point and the static point cloud in response to the current scan point not overlapping with the preset point cloud.

7. The automated moving vehicle according to claim 6, wherein the processor is further configured to execute:
determining a moving path of the automated moving vehicle according to the preset point cloud and the static point cloud.

8. The automated moving vehicle according to claim 1, wherein the processor is further configured to execute:
controlling the driving device to move the automated moving vehicle along a moving path before obtaining the current scan point; and
controlling the driving device to move the automated moving vehicle along the same movement path in response to the shortest distance being greater than or equal to the first threshold.

9. The automated moving vehicle according to claim 1, further comprising:
an inertial measurement unit, coupled to the processor and measuring an acceleration of the automated moving vehicle, wherein the processor determines the second threshold based on the acceleration.

10. The automated moving vehicle according to claim 1, wherein the processor is further configured to execute:
dividing the current point cloud into a plurality of clusters, wherein the clusters comprises a first cluster, wherein a distance between each of the first clusters and the static point cloud is greater than or equal to the first threshold;
executing a clustering algorithm on the clusters to update the clusters, and determining whether the current scan point is located in the first cluster that is updated; and
calculating the first distance in response to the current scan point being located in the first cluster that is updated.

11. A control method of an automated moving vehicle, comprising:
obtaining a static point cloud and a current point cloud on a work space through a sensor, wherein the current point cloud comprises a current scan point;
calculating a shortest distance between the current scan point and the static point cloud;
calculating a first distance between the current scan point and the automated moving vehicle in response to the shortest distance being greater than or equal to a first threshold; and
controlling a driving device of the automated moving vehicle to stop a movement of the automated moving vehicle in response to the first distance being less than a second threshold.
